(19) United States
(12) Patent Application Publication
(10) Pub. No.: US 2025/0063400 A1
(43) Pub. Date: Feb. 20, 2025

(54) RESOURCE INDICATION METHOD AND APPARATUS, INFORMATION RECEIVING METHOD AND APPARATUS, COMMUNICATION DEVICE AND COMPUTER READABLE STORAGE MEDIUM

(71) Applicant: Beijing Xiaomi Mobile Software Co., Ltd., Beijing (CN)

(72) Inventor: Qun ZHAO, Beijing (CN)

(73) Assignee: Beijing Xiaomi Mobile Software Co., Ltd., Beijing (CN)

(21) Appl. No.: 18/715,972

(22) PCT Filed: Dec. 2, 2021
(86) PCT No.: PCT/CN2021/135188

§ 371 Date: Jun. 3, 2024

(51) Int. Cl. H04W 24/08; H04W 72/044; H04W 72/23

(52) U.S. Cl. CPC H04W 24/08; H04W 72/044; H04W 72/23

(57) ABSTRACT

The present application relates to a resource indication method and apparatus, and an information receiving method and apparatus, communication device and computer readable storage medium. The resource indication method includes: determining resources for performing interference measurement; and sending, to a terminal, first indication information for indicating configuration information for the resources.

### CROSS REFERENCE TO RELATED APPLICATIONS

The present application is a U.S. National Stage of International Application No. PCT/CN2021/135188 filed on Dec. 2, 2021, the content of which is incorporated herein by reference in its entirety.

### TECHNICAL FIELD

The present disclosure relates to the field of communication technology, and in particular, to a resource indication method, an information receiving method, a resource indication apparatus, an information receiving apparatus, a communication device, and a computer-readable storage medium.

### BACKGROUND

In communication systems, communication based on full-duplex mode, which supports simultaneous uplink transmission and downlink transmission in a same slot, is proposed out of consideration for increasing throughput, reducing transmission delay, and enhancing uplink coverage.

Due to limited capabilities of suppressing self-interference of a terminal, at present the full-duplex mode is mainly considered on the network side. However, communication based on the full-duplex mode on the network side is usually similar to a half-duplex mode, leading to more communication resources to be interfered with.

### SUMMARY

According to a first aspect of embodiments of the present disclosure, a resource indication method is proposed which is performed by a network-side device. The resource indication method includes: determining resources for performing interference measurement; and sending, to a terminal, first indication information for indicating configuration information for the resources.

According to a second aspect of embodiments of the present disclosure, an information receiving method is proposed which is performed by a terminal. The information receiving method includes: receiving first indication information from a network-side device; and determining, based on the first indication information, configuration information for resources for the network-side device performing interference measurement.

According to a third aspect of embodiments of the present disclosure, a resource indication apparatus is proposed which includes one or more processors. The processors is configured for: determining resources for performing interference measurement; and sending, to a terminal, first indication information for indicating configuration information for the resources.

According to a fourth aspect of embodiments of the present disclosure, an information receiving apparatus is proposed which includes one or more processors. The processors is configured for implementing the information receiving method.

According to a fifth aspect of embodiments of the present disclosure, a communication device is proposed including: a processor; a memory for storing a computer program; where the computer program, when is executed by the processor, implements the resource indication method.

According to a sixth aspect of embodiments of the present disclosure, a communication device is proposed including: a processor; a memory for storing a computer program; where the computer program, when is executed by the processor, implements the information receiving method.

According to a seventh aspect of embodiments of the present disclosure, a computer-readable storage medium is proposed for storing a computer program, where the computer program, when is executed by a processor, implements the resource indication method.

### BRIEF DESCRIPTION OF DRAWINGS

In order to more clearly illustrate the technical solutions in the examples of the present disclosure, the drawings used in the description of the examples will be briefly described below. It is obvious that the drawings in the following description are only some examples of the present disclosure, and other drawings may also be obtained from those of ordinary skill in the art without paying inventive efforts in view of the drawings.

FIG. 1 is a schematic flowchart illustrating a resource indication method according to embodiments of the present disclosure.

FIG. 2 is a schematic diagram illustrating a pattern according to embodiments of the present disclosure.

FIG. 3 is a schematic diagram illustrating another pattern according to embodiments of the present disclosure.

FIG. 4 is a schematic diagram illustrating yet another pattern according to embodiments of the present disclosure.

FIG. 5 is a schematic diagram illustrating a resource according to embodiments of the present disclosure.

FIG. 6 is a schematic diagram illustrating another pattern according to embodiments of the present disclosure.

FIG. 7 is a schematic flowchart illustrating another resource indication method according to embodiments of the present disclosure.

FIG. 8 is a schematic flowchart illustrating yet another resource indication method according to embodiments of the present disclosure.

FIG. 9 is a schematic diagram illustrating activation/de-activation according to embodiments of the present disclosure.

FIG. 10 is a schematic flowchart illustrating an information receiving method according to embodiments of the present disclosure.

FIG. 11 is a schematic flowchart illustrating another information receiving method according to embodiments of the present disclosure.

FIG. 12 is a schematic flowchart illustrating yet another information receiving method according to embodiments of the present disclosure.

FIG. 13 is a schematic block diagram illustrating a resource indication apparatus according to embodiments of the present disclosure.

FIG. 14 is a schematic block diagram illustrating an information receiving apparatus according to embodiments of the present disclosure.

### DETAILED DESCRIPTION

The technical solutions in the examples of the present disclosure are clearly and completely described in the following with reference to the drawings in the examples of the present disclosure. It is obvious that the described examples are only a part of the examples of the present disclosure, and not all of the examples. All other examples obtained by a person of ordinary skill in the art based on the examples of the present disclosure without paying inventive efforts are within the scope of the present disclosure.

The term used in the present disclosure is for the purpose of describing particular examples only and is not intended to limit the present disclosure. As used in this disclosure and the appended claims, the singular forms “a”, “an” and “the” are intended to include the plural forms as well, unless the context clearly indicates otherwise. It should also be understood that the term “and/or” as used herein refers to and includes any and all possible combinations of one or more of the associated listed items.

It shall be understood that, although the terms “first,” “second,” “third,” and the like may be used in the embodiments of the present disclosure to describe various information, the information should not be limited by these terms. These terms are only used to distinguish one category of information from another. For example, without departing from the scope of the embodiments of the present disclosure, first information may be referred as second information; and similarly, second information may also be referred as first information. Depending on the context, the term “if” as used herein may be interpreted as “when” or “upon” or “in response to determining”.

For the purposes of brevity and ease of understanding, the terms “greater than” or “less than”, “above” or “below” are used herein to represent size relationships. However, for those skilled in the art, it is understood that the term “greater than” also covers the meaning of “greater than or equal to”, and the term “less than” also covers the meaning of “less than or equal to”; the term “above” covers the meaning of “above or equal to” and the term “below” covers the meaning of “below or equal to”.

When a network-side device communicates based on a half-duplex mode, interference generally exists only in uplink resources, and the work of performing an interference measurement is mainly focused on the terminal side. Downlink resources, such as downlink slots in a time division duplex (TDD) frequency band and downlink spectrums in a frequency division duplex (FDD) frequency band, are only used for downlink transmission in the half-duplex mode, so the current network-side device does not perform the interference measurement on the downlink resources.

However, when the network-side device communicates based on a full-duplex mode, there will be interference on the downlink resources, so it is necessary to perform the interference measurement on the downlink resources. However, the terminal does not know on which resources the network-side device performs the interference measurement, which will lead to some technical problems. For example, the network-side device will not perform downlink transmission of data or reference signals (RSs) on the resources where the interference measurement is performed. If the terminal still receives the data or reference signals on these resources, resources of the terminal will be wasted, and problems such as demodulation errors even occur.

In view of this, embodiments of the present disclosure propose a resource indication method, an information receiving method, a resource indication apparatus, an information receiving apparatus, a communication device, and a computer-readable storage medium to solve technical problems in the related art.

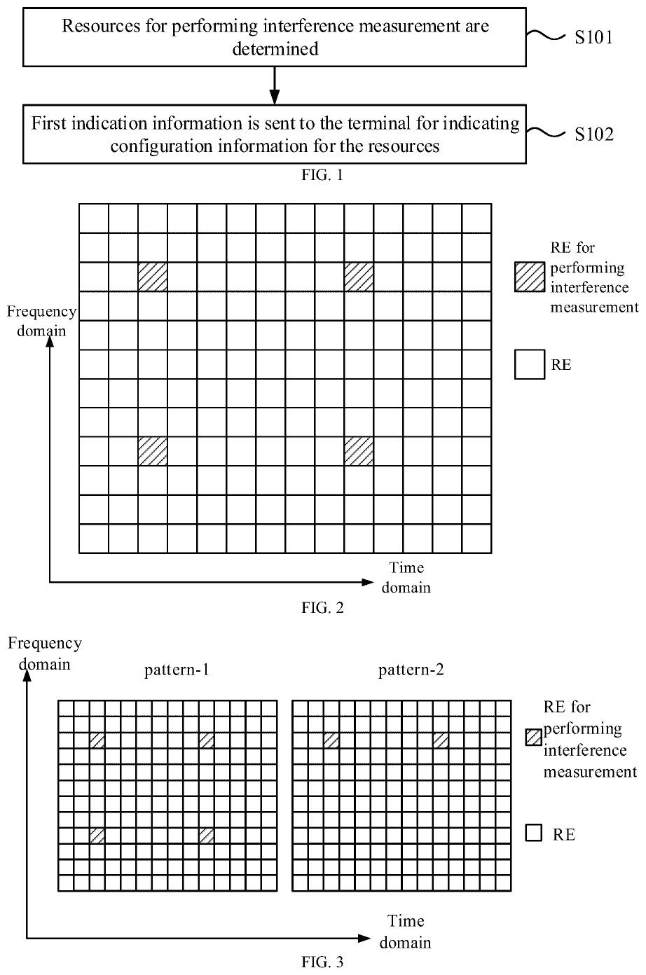

FIG. 1 is a schematic flowchart illustrating a resource indication method according to embodiments of the present disclosure. The resource indication method shown in this embodiment may be performed by a network-side device, the network-side device includes but is not limited to a network-side device in a communication system such as 4G, 5G, 6G, etc., including a base station, a core network and so on. The network-side device may be in communication with a terminal, and the terminal includes but is not limited to a communication device such as a cell phone, a tablet, a wearable device, a sensor, an Internet of Things device, etc.

As shown in FIG. 1, the resource indication method may include steps S101 and S102.

In step S101, resources for performing an interference measurement are determined.

In step S102, first indication information is sent to the terminal, the first indication information is used for indicating configuration information for the resources.

In an embodiment, the network-side device may determine the resources for performing the interference measurement based on needs for the interference measurement. For example, the resources include downlink resources, which may specifically include at least one of the following: downlink resources of a time division duplex (TDD) frequency band (e.g., downlink slots of the TDD frequency band); and downlink resources of a frequency division duplex (FDD) frequency band (e.g., downlink spectrums of the FDD frequency band). Of course, the resources may further include uplink resources, such as uplink resources of the TDD frequency band (e.g., uplink slots of the TDD frequency band), and uplink resources of the FDD frequency band (e.g., uplink spectrums of the TDD frequency band), which may be determined in accordance with the needs for the interference measurement. The following embodiments are illustrated for example mainly in a case where the resources are the downlink resources.

In an embodiment of the present disclosure, first indication information is used for indicating to the terminal that the network-side device stops sending transmissions (including the data and/or reference signals) on the resources corresponding to the configuration information. In another embodiment of the present disclosure, the first indication information is used for instructing the terminal to stop receiving transmissions (including the data and/or reference signals) on the resources corresponding to the configuration information, or not to receive transmissions (including data and/or reference signals) on the resources corresponding to the configuration information. In a further embodiment of the present disclosure, the first indication information is used for instructing the terminal to perform rate matching on the resources to stop receiving the data and reference signals sent by the network-side device on the resources.

In an embodiment, the network-side device may communicate based on the full-duplex mode, the full-duplex mode indicating simultaneous uplink transmission and downlink transmission in a same frequency domain resource (e.g., a frequency band, carrier, subcarrier, bandwidth part, resource block, resource element, etc.). In an embodiment, the method further includes: stopping sending data and reference signals on the resources.

In the case of the network-side device communicating based on the full-duplex mode, interference may exist on the downlink resources, and therefore the interference measurement needs to be performed on the resources. When performing the interference measurement, in order to obtain an accurate measurement result, the network-side device may stop sending data, reference signals, and the like on the resources.

According to the embodiments of the present disclosure, the network-side device, after determining the resources used for performing an interference measurement, may indicate the configuration information of the resources used for performing the interference measurement to the terminal via the first indication information. In this way, the terminal is enabled to, based on the configuration information, determine the resources used by the network-side device for performing the interference measurement, so that the terminal will not expect to receive data, reference signals, and the like sent by the network-side device on those resources. For example, the terminal can perform rate matching for the resources to stop receiving data, reference signals, etc. sent by the network-side device on the resources. Accordingly, problems such as wasting resources of the terminal and demodulation errors can be avoided.

In an embodiment, the first indication information includes at least one of the following: Downlink Control Information (DCI); and Media Access Control Control Element (MAC CE).

The network-side device may send the DCI as the first indication information carrying the configuration information for the resources to the terminal, or may send the MAC CE as the first indication information carrying the configuration information for the resources to the terminal.

In an embodiment, the DCI includes common Downlink Control Information (common DCI).

The network-side device may send the common DCI as the first indication information carrying the configuration information for the resources to the terminal. When the network-side device performs the interference measurement on the resources, all the terminals in a corresponding cell of the network-side device should not expect to receive the data and reference signals sent by the network-side device on the resources. Therefore, it is possible to indicate the configuration information to all the terminals in the corresponding cell of the network-side device collectively through the common DCI (e.g., by multicasting), without having to indicate separately to each terminal, which is conducive to saving resources.

The DCI can be in a newly defined DCI format, or it can follow a current DCI format, such as a DCI format 1_1, DCI format 1_2, etc.

In an embodiment, the configuration information includes at least one of the following: frequency domain occupancy information, time domain occupancy information, a time domain resource range, and pattern information for the frequency domain occupancy information and the time domain occupancy information. In some possible embodiments, the time domain resource range may be a time window length.

In an embodiment, the configuration information for the resources indicated by the network-side device may include the frequency domain occupancy information and the time domain occupancy information, whereby locations of the resources in a frequency domain and a time domain may be determined. For example, resource blocks (RBs) in a certain slot corresponding to the frequency domain occupancy information and the time domain occupancy information may be determined, or more specifically, corresponding Resource Elements (REs) may be determined.

In an embodiment, the configuration information for the resources indicated by the network-side device may further include the time domain resource range, which indicates that the resources may be determined, in how many slots, based on the frequency domain occupancy information and the time domain occupancy information.

The terminal may predetermine a plurality of time domain resource ranges, which may be determined, for example, according to a protocol agreement, or according to a network-side configuration. Subsequently, the network-side device may indicate a time domain resource range among these plurality of time domain resource ranges, for example, indicate an identification corresponding to the time domain resource range. As an example, an association between the identification of the time domain resource range and the time domain resource may be as shown in the following Table 1.

TABLE 1

| Time window | Time window |
|---|---|
| identification | length |
| 00 | 1 |
| 01 | 5 |
| 10 | 10 |
| 11 | 20 |

As shown in the Table 1, the terminal predetermines 4 time window lengths (i.e., time domain resource ranges), and the network-side device may determine log₂(W) bits indicating the time window identification, with W being equal to 4 in the embodiment of Table 1. Take the identification being 01 as an example, it can be determined that the corresponding time window length is 5 based on the Table 1, and then it can be determined that there are resources in 5 slots that are used by the network-side device to perform the interference measurement.

It is understood that each of the elements in the Table 1 exists independently of each other. These elements are listed in the same table as an example, but it is not indicated that all of these elements in the table must exist at the same time as shown in the table. A value of each of these elements is independent of any other values of these elements in the Table 1. Thus, it can be understood by those skilled in the art that the value of each of the elements in the Table 1 corresponds to an independent embodiment.

Also, it is noted that in a case where the time domain resource range is indicated by MAC CE, since it takes a period of time, for example, 3 milliseconds, for the terminal to parse the MAC CE, the start time of the time domain resource range is at least 3 milliseconds after a downlink slot of a hybrid automatic retransmission request corresponding to the MAC CE. In some embodiments, the MAC CE indicates the time domain resource range as T₀+δt; where the T₀ is an end time of the downlink slot of the hybrid automatic retransmission request corresponding to the MAC CE. The δt may be determined based on a communication standard or may be configured by a base station.

In an embodiment, the configuration information for the resources indicated by the network-side device may also include pattern information of the frequency domain occupancy information and the time domain occupancy information. The terminal, based on the pattern information, may determine on which REs in the RB the network-side device performs interference measurement. Since the pattern information includes both the frequency domain occupancy information and the time domain occupancy information, indicating the pattern information may result in a relative reduction in resource overhead as compared to indicating the frequency domain occupancy information and the time domain occupancy information separately.

In an embodiment, the frequency domain occupancy information includes a frequency domain start location and a frequency domain range.

The network-side device may indicate the frequency domain occupancy information by indicating the frequency domain start location and the frequency domain range. Based on the frequency domain start location and the frequency domain range, frequency domain locations of the resources that are used by the network-side device to perform interference measurement may be determined.

FIG. 2 is a schematic diagram illustrating a pattern according to embodiments of the present disclosure.

Information of the pattern (pattern information) can define a location of an RE in an RB, where one RB corresponds to one slot in the time domain and 12 subcarriers in the frequency domain, where the slot contains 14 symbols in the time domain. As shown in FIG. 2, based on the information of the pattern, four REs in one RB can be determined for performing interference measurement, the four REs being on the 3rd and 10th symbols and corresponding to (counting from the top) the 3rd and 9th subcarriers, respectively.

FIG. 3 is a schematic diagram illustrating another pattern illustrated according to embodiments of the present disclosure.

The terminal may predetermine a plurality of patterns, for example, based on protocol agreements, or by configurations distributed by the network-side device (e.g., through radio resource control (RRC) signaling). The network-side device may indicate to the terminal one of these plurality of patterns as the pattern information for the resources.

As shown in FIG. 3, the terminal predetermines two kinds of patterns, pattern-1 and pattern-2, respectively. The network-side device can indicate one of these two patterns to the terminal by pattern indication information, e.g., indicating the pattern-1 to the terminal, and then the terminal can determine the RE for performing interference measurement based on the pattern-1.

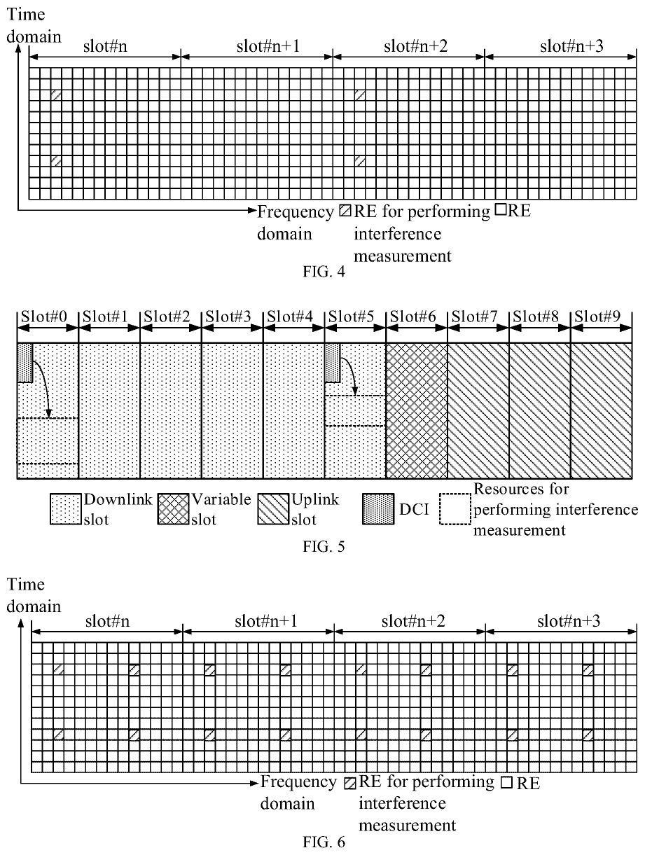

FIG. 4 is a schematic diagram illustrating yet another pattern according to embodiments of the present disclosure.

The pattern information can define locations of REs in a plurality of RBs, the plurality of RBs corresponding to a plurality of slots. For example, as shown in FIG. 4, the pattern information can define locations of REs in four consecutive RBs (corresponding to four slots, slot#n to slot#n+3).

In an embodiment, the pattern information is determined based on the protocol agreement or is determined by the network-side device and indicated to the terminal. In an example, the method may further include: indicating the pattern information to the terminal.

The pattern information in the configuration information may be determined based on the protocol agreement. For example, a plurality of patterns are determined based on the protocol agreement. The network-side device may indicate one of the plurality of patterns to the terminal through pattern indication information. The pattern information in the configuration information may also be indicated by the network-side device. For example, the network-side device may indicate specific pattern information directly. In another example, it is also possible that the terminal first determines a plurality of patterns based on the protocol agreement, and the network-side device may indicate one pattern of these plurality of patterns to the terminal through the pattern indication information.

In an embodiment, granularity of the pattern information is determined based on the protocol agreement or is determined by the network-side device and indicated to the terminal. In an example, the method may further include: indicating the granularity to the terminal.

In a case where the network-side device indicates the pattern information, it may not be necessary to indicate the time domain occupancy information and the frequency domain occupancy information since the pattern information contains both the time domain occupancy information and the frequency domain occupancy information. But in this case, it is difficult to determine a scope of application of the pattern information in the frequency domain. Therefore, it is also necessary to determine a specific granularity corresponding to the scope of application of the pattern information in the frequency domain. The granularity is, for example, one or more RBs, one or more REs, etc., where the granularity may be determined based on a protocol agreement or may be indicated to the terminal by the network-side device.

FIG. 5 is a schematic diagram illustrating a resource according to embodiments of the present disclosure.

As shown in FIG. 5, for example, for the TDD frequency band, uplink TDD slots and downlink TDD slots are structured as six downlink slots (slot#0 to slot#5), one variable slot (slot#6), and three uplink slots (slot#7 to slot#9), i.e., DDDDDDSUUU.

The network-side device performs interference measurement on some of the resources in slots slot#0 and slot#5, then the DCI can be sent in the slot#0 with the DCI indicating the configuration information of the resources used for interference measurement in the slot#0, and the DCI can be sent in the slot#5 with the DCI indicating the configuration information of the resources used for interference measurement in the slot#5. The resources used to perform interference measurement in the slot#0 and slot#5 can be the same or different, as determined by the network-side device as needed.

FIG. 6 is a schematic diagram illustrating another pattern according to embodiments of the present disclosure.

In an embodiment, the configuration information may include the pattern information, and the network-side device also indicates the granularity. For example, as shown in FIG. 6, the granularity is four RBs (corresponding to four slots from slot#n to slot#n+3), then the scope of application of the pattern in the frequency domain is four RBs, with each pattern of the REs in each of this four RBs is the same.

FIG. 7 is a schematic flowchart illustrating another resource indication method according to embodiments of the present disclosure. As shown in FIG. 7, sending the first indication information to the terminal includes steps S101, S701, and S702. Step S101, as taught with reference to FIG. 1 herein, is not repeated.

In step S701, target identification corresponding to the configuration information is determined based on the association between the identification and the configuration information.

In step S702, the target identification is carried in the first indication information to be sent to the terminal.

In an embodiment, a plurality of configuration information of the resources for performing interference measurement may be predetermined, and the association between the configuration information of the resources for performing interference measurement and the identifications may be stored in advance. In this way, the network-side device, when indicating the configuration information, may indicate the target identification to which the configuration information corresponds in the association, whereby it is advantageous to save the resource overhead of the indication process.

The association may be stored in the form of a table, or may be stored by other means. Take the table as an example, as shown in Table 2 below:

TABLE 2

| Entry | Frequency | RE | Time |
|---|---|---|---|
| index | domain range | pattern | window |
| #0 | Upper ½ BWP | Pattern#1 | Window#1 |
| #1 | Lower ½ BWP | Pattern#1 | Window#1 |
| #2 | Full BWP | Pattern#2 | Window#2 |
| #3 | Full BWP | Pattern#2 | Window# 1 |

It is understood that each of the elements in the Table 2 exists independently of each other. These elements are listed in the same table as an example, but it is not indicated that all of these elements in the table must exist at the same time as shown in the table. A value of each of these elements is independent of any other values of these elements in the Table 2. Thus, it can be understood by those skilled in the art that the value of each of the elements in the Table 2 corresponds to an independent embodiment.

The configuration information includes the frequency domain range, the time window (i.e., time domain resource range) and the RE pattern (i.e., the pattern information), with the entry index being an identification. For example, there exists the configuration information of M sets of resources. The network-side device can indicate the identification through the DCI, for example, ceil(log 2(M)) bits are carried through the DCI to indicate the configuration information of one set of resources in the configuration information of M sets of resources. For example, as shown in the Table 2, M=4, then the configuration information can be indicated through 2 bits. The relationship between indication carried in the DCI and the identification can be shown in Table 3.

TABLE 3

| Indication | |
|---|---|
| carried in | |
| the DCI | Entry index |
| 00 | Entry #0 |
| 01 | Entry #1 |
| 10 | Entry #2 |
| 11 | Entry #3 |

For example, if the indication carried in the DCI is 00, then the identification corresponding to the indication can be determined to be Entry #0, and then it is determined that the configuration information corresponding to Entry #0 is the configuration information of the resources used by the network-side device to perform the interference measurement according to the Table 3. It is understood that each of the elements in the Table 3 exists independently of each other. These elements are listed in the same table as an example, but it is not indicated that all of these elements in the table must exist at the same time as shown in the table. A value of each of these elements is independent of any other values of these elements in the Table 3. Thus, it can be understood by those skilled in the art that the value of each of the elements in the Table 3 corresponds to an independent embodiment.

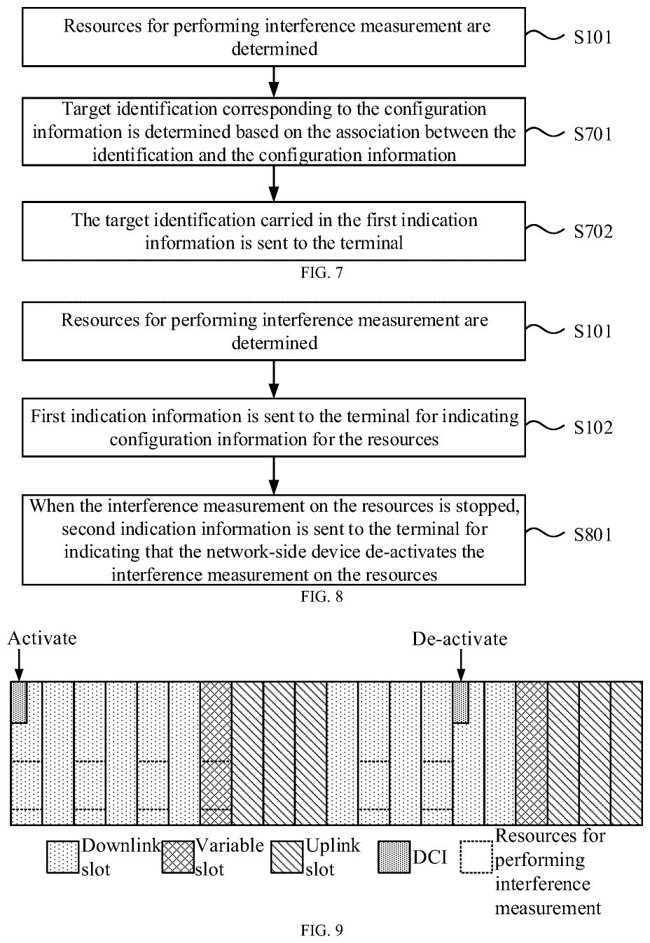

FIG. 8 is a schematic flowchart illustrating yet another resource indication method according to embodiments of the present disclosure. As shown in FIG. 8, the method of FIG. 1, not repeated here, further includes step S801.

In step S801, when the interference measurement on the resources is stopped, second indication information is sent to the terminal for indicating that the network-side device de-activates the interference measurement on the resources.

In an embodiment, the interference measurement performed by the network-side device may be stopped as needed. When the interference measurement on the resources is stopped, the second indication information may be indicated to the terminal to determine that the network-side device de-activates the interference measurement on the resources.

In an embodiment of the present disclosure, the second indication information is used to indicate to the terminal that the network-side device stops performing interference measurement on the resources. In a possible embodiment of the present disclosure, the first indication information is used to instruct the terminal to start receiving transmissions (including the data and/or reference signals) on the resources corresponding to the configuration information, or to start performing a preset operation on the resources corresponding to the configuration information.

In an embodiment, the method further includes: sending at least one of the following on the resources: data or reference signals. When the network-side device stops performing interference measurement on the resources, the data or reference signals, etc. may be sent on the resources, and accordingly, the terminal may receive data or reference signals, etc. on the resources.

In an embodiment, the network-side device pre-configures configuration information for a plurality of resources for the terminal, and the first indication information is for indicating the configuration information for the resources for performing interference measurement activated by the network-side device among the plurality of resources. In an embodiment of the present disclosure, the first indication information and the second indication information may be the same information, and the network-side device may indicate information related to starting the interference measurement and ending the interference measurement by one indication information.

In some embodiments, the network-side device may pre-configure configuration information for a plurality of resources for the terminal, and activate, by the first indication information, one of the configuration information as the configuration information for the resources used by the network-side device for interference measurement; and the first indication information can indicate a start/end time for interference measurement to the terminal in order to instruct the terminal to stop receiving transmissions (including the data and/or reference signals) between the start time and end time.

FIG. 9 is a schematic diagram illustrating activation/de-activation according to embodiments of the present disclosure.

The network-side device indicates the resources used by the network-side device to perform interference measurement to the terminal by the first indication information. For example, as shown in FIG. 9, the resources have a period of 2 slots, i.e., the network-side device performs the interference measurement on the resources according to the period, and the terminal stops receiving the data or the reference signals on the resources according to the period.

The network-side device stops performing the interference measurement on the resources after completing the interference measurement (or for other reasons), which can be indicated to the terminal by the first indication information, to make the terminal determine that the network-side device stops performing the interference measurement on the resources. That is, the network-side device stops performing the interference measurement on the resources, and thus, can send data or reference signals on the resources, and the terminal can also receive data or reference signals on the resources.

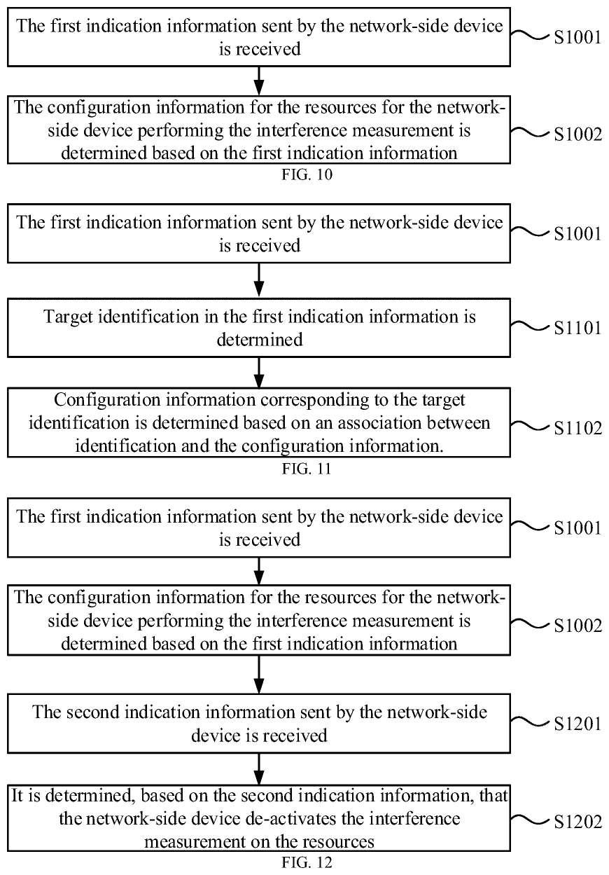

FIG. 10 is a schematic flowchart illustrating an information receiving method according to embodiments of the present disclosure. The information receiving method shown in this embodiment may be performed by the terminal. The terminal includes but is not limited to a communication device such as a cell phone, a tablet computer, a wearable device, a sensor, an IoT device, etc., and the terminal can communicate with the network-side device. The network-side device includes but is not limited to a network-side device in a communication system like a 4G, a 5G, and a 6G communication system, such as a base station, a core network, etc.

As shown in FIG. 10, the information receiving method includes steps S1001 and S1002.

In step S1001, the first indication information sent by the network-side device is received.

In step S1002, the configuration information for the resources for the network-side device to perform the interference measurement is determined based on the first indication information.

In an embodiment, the network-side device may determine the resources for performing the interference measurement based on needs for the interference measurement, for example, the resources include downlink resources, which may specifically include at least one of the following: downlink resources of a time division duplex (TDD) frequency band (e.g., downlink slots of the TDD frequency band); and downlink resources in a frequency division duplex (FDD) frequency band (e.g., downlink spectrums of the FDD frequency band). Of course, the resources may further include uplink resources, such as uplink resources of the TDD frequency band (e.g., uplink slots of the TDD frequency band), and uplink resources of the FDD frequency band (e.g., uplink spectrums of the FDD frequency band), which may be determined in accordance with the needs for the interference measurement. The following embodiments are illustrated for example mainly in a case where the resources are the downlink resources.

In an embodiment, the network-side device may communicate based on the full-duplex mode, the full-duplex mode indicating simultaneous uplink transmission and downlink transmission in a same frequency domain resource (e.g., a frequency band, carrier, subcarrier, bandwidth part, resource block, resource element, etc.). In an embodiment, the method further includes: stopping sending data and reference signals on the resources.

In the case of the network-side device communicating based on the full-duplex mode, interference may exist on the downlink resources, and therefore the interference measurement needs to be performed on the resources. When performing the interference measurement, in order to obtain an accurate measurement result, the network-side device may stop sending data, reference signals, and the like on the resources.

According to the embodiments of the present disclosure, the network-side device, after determining the resources used for performing an interference measurement, may indicate the configuration information of the resources used for performing the interference measurement to the terminal via the first indication information. In this way, the terminal is enabled to, based on the configuration information, determine the resources used by the network-side device for performing the interference measurement, so that the terminal will not expect to receive data, reference signals, and the like sent by the network-side device on those resources. Accordingly, problems such as wasting resources of the terminal and demodulation errors can be avoided.

In addition, it is noted that in some cases, the downlink data channel may conflict with the resources. That is, on the one hand, the terminal determines that downlink data is received on the resources, and on the other hand, the terminal determines that the network-side device performs the interference measurement on the resources based on the first indication information. In this case, the terminal may prioritize determining that the network-side device performs the interference measurement on the resources, perform rate matching for the resources and do not expect to receive data or reference signals sent by the network-side device on the resources.

In an embodiment, the method further includes: performing rate matching for the resources and stopping receiving data or reference signals sent by the network-side device on the resources. That is, the terminal may perform rate matching for the resources to stop receiving data or reference signals sent by the network-side device on the resources.

In an embodiment, the first indication information includes at least one of: Downlink Control Information (DCI); or Media Access Control Control Element (MAC CE).

The network-side device may send the DCI as the first indication information carrying the configuration information for the resources to the terminal, or may send the MAC CE as the first indication information carrying the configuration information for the resources to the terminal.

In an embodiment, the DCI includes common Downlink Control Information (common DCI).

The network-side device may send the common DCI as the first indication information carrying the configuration information for the resources to the terminal. When the network-side device performs the interference measurement on the resources, all the terminals in a corresponding cell of the network-side device should not expect to receive the data and reference signals sent by the network-side device on the resources. Therefore, it is possible to indicate the configuration information to all the terminals in the corresponding cell of the network-side device collectively through the common DCI (e.g., by multicasting), without having to indicate separately to each terminal, which is conducive to saving resources.

The DCI can be in a newly defined DCI format, or it can follow a current DCI format, such as a DCI format 1_1, DCI format 1_2, etc.

In an embodiment, the configuration information includes at least one of: frequency domain occupancy information, time domain occupancy information, a time domain resource range, and pattern information for the frequency domain occupancy information and the time domain occupancy information.

In an embodiment, the configuration information for the resources indicated by the network-side device may include the frequency domain occupancy information and the time domain occupancy information, whereby locations of the resources in a frequency domain and a time domain may be determined. For example, resource blocks (RBs) in a certain slot corresponding to the frequency domain occupancy information and the time domain occupancy information may be determined, or more specifically, corresponding resource elements (REs) may be determined.

In an embodiment, the configuration information for the resources indicated by the network-side device may further include the time domain resource range, which indicates that the resources may be determined, in how many slots, based on the frequency domain occupancy information and the time domain occupancy information.

The terminal may predetermine a plurality of time domain resource ranges, which may be determined, for example, according to a protocol agreement, or according to a network-side configuration. Subsequently, the network-side device may indicate a time domain resource range among these plurality of time domain resource ranges, for example, indicate an identification corresponding to the time domain resource range. As an example, an association between the identification of the time domain resource range and the time domain resource may be as shown in the preceding Table 1.

As shown in the Table 1, the terminal predetermines 4 time window lengths (i.e., time domain resource ranges), and the network-side device may determine log₂(W) bits indicating the time window identification, with W being equal to 4 in the embodiment of Table 1. Take the identification being 01 as an example, it can be determined that the corresponding time window length is 5 based on the Table 1, and then it can be determined that there are resources in 5 slots that are used by the network-side device to perform the interference measurement.

Also, it is noted that in a case where the time domain resource range is indicated by MAC CE, since it takes a period of time, for example 3 milliseconds, for the terminal to parse the MAC CE, the start time of the time domain resource range is at least 3 milliseconds after a downlink slot of a hybrid automatic retransmission request corresponding to the MAC CE.

In an embodiment, the configuration information for the resources indicated by the network-side device may also include pattern information of the frequency domain occupancy information and the time domain occupancy information. The terminal, based on the pattern information, may determine on which REs in the RB the network-side device performs interference measurement. Since the pattern information includes both the frequency domain occupancy information and the time domain occupancy information, indicating the pattern information may result in a relative reduction in resource overhead as compared to indicating the frequency domain occupancy information and the time domain occupancy information separately.

In an embodiment, the frequency domain occupancy information includes a frequency domain start location and a frequency domain range.

The network-side device may indicate the frequency domain occupancy information by indicating the frequency domain start location and the frequency domain range. Based on the frequency domain start location and the frequency domain range, frequency domain locations of the resources that are used by the network-side device to perform interference measurement may be determined.

The terminal may predetermine a plurality of patterns, for example, based on protocol agreements, or by configurations distributed by the network-side device (e.g., through radio resource control (RRC) signaling). The network-side device may indicate to the terminal one of these plurality of patterns as the pattern information for the resources.

As shown in FIG. 3, the terminal predetermines two kinds of patterns, pattern-1 and pattern-2 respectively. The network-side device can indicate one of these two patterns to the terminal by pattern indication information, e.g., indicating the pattern-1 to the terminal, and then the terminal can determine the RE for performing interference measurement based on the pattern-1.

The pattern information can define locations of REs in a plurality of RBs, the plurality of RBs corresponding to a plurality of slots. For example, as shown in FIG. 4, the pattern information can define locations of REs in four consecutive RBs (corresponding to four slots, slot#n to slot#n+3).

In an embodiment, the pattern information is determined based on the protocol agreement or is determined by the network-side device and indicated to the terminal. In an example, the method may further include: receiving information indicating the pattern information from the network-side device.

The pattern information in the configuration information may be determined based on the protocol agreement. For example, a plurality of patterns are determined based on the protocol agreement. The network-side device may indicate one of the plurality of patterns to the terminal through pattern indication information. The pattern information in the configuration information may also be indicated by the network-side device. For example, the network-side device may indicate specific pattern information directly. In another example, it is also possible that the terminal first determines a plurality of patterns based on the protocol agreement, and the network-side device may indicate one pattern of these plurality of patterns to the terminal through the pattern indication information.

In an embodiment, the pattern information is determined based on the protocol agreement, or is determined by the network-side device and indicated to the terminal. That is, the method further includes: determining the pattern information based on indication of the network-side device.

In a case where the network-side device indicates the pattern information, it may not be necessary to indicate the time domain occupancy information and the frequency domain occupancy information since the pattern information contains both the time domain occupancy information and the frequency domain occupancy information. But in this case, it is difficult to determine a scope of application of the pattern information in the frequency domain. Therefore, it is also necessary to determine a specific granularity corresponding to the scope of application of the pattern information in the frequency domain. The granularity is, for example, one or more RBs, one or more REs, etc., where the granularity may be determined based on a protocol agreement or may be indicated to the terminal by the network-side device.

In an embodiment, granularity of the pattern information is determined based on the protocol agreement. In another example, the method further includes: determining the granularity according to indication from the network-side device.

In a case where the network-side device indicates the pattern information, it may not be necessary to indicate the time domain occupancy information and the frequency domain occupancy information since the pattern information contains both the time domain occupancy information and the frequency domain occupancy information. But in this case, it is difficult to determine a scope of application of the pattern information in the frequency domain. Therefore, it is also necessary to determine a specific granularity corresponding to the scope of application of the pattern information in the frequency domain. The granularity is, for example, one or more RBs, one or more REs, etc., where the granularity may be determined based on a protocol agreement or may be indicated to the terminal by the network-side device.

As shown in FIG. 5, for example, for the TDD frequency band, uplink TDD slots and downlink TDD slots are structured as six downlink slots (slot#0 to slot#5), one variable slot (slot#6), and three uplink slots (slot#7 to slot#9), i.e., DDDDDDSUUU.

The network-side device performs interference measurement on some of the resources in slots slot#0 and slot#5, then the DCI can be sent in the slot#0 with the DCI indicating the configuration information of the resources used for interference measurement in the slot#0, and the DCI can be sent in the slot#5 with the DCI indicating the configuration information of the resources used for interference measurement in the slot#5. The resources used to perform interference measurement in the slot#0 and slot#5 can be the same or different, as determined by the network-side device as needed.

In an embodiment, the configuration information may include the pattern information, and the network-side device also indicates the granularity. For example, as shown in FIG. 6, the granularity is four RBs (corresponding to four slots from slot#n to slot#n+3), then the scope of application of the pattern in the frequency domain is four RBs, with each pattern of the REs in each of this four RBs is the same.

FIG. 11 is a schematic flowchart illustrating another information receiving method according to embodiments of the present disclosure. As shown in FIG. 11, determining the configuration information for the resources for the network-side device performing interference measurement based on the first indication information includes S1001, from FIG. 10, and steps S1101 and S1102.

In step S1101, target identification in the first indication information is determined.

In step S1102, the configuration information is determined based on the target identification.

In a possible implementation, the terminal determines the configuration information corresponding to the target identification based on the association between the target identification and the configuration information.

In an embodiment, a plurality of configuration information of the resources for performing interference measurement may be predetermined, and the association between the configuration information of the resources for performing interference measurement and the identification may be stored in advance. In this way, the network-side device, when indicating the configuration information, may indicate the target identification to which the configuration information corresponds in the association, whereby it is advantageous to save the resource overhead of the indication process.

The association may be stored in the form of a table, or may be stored by other means.

Take the table as an example, as shown in the preceding table 2.

The configuration information includes the frequency domain range, the time window (i.e., time domain resource range) and the RE pattern (i.e., the pattern information), with the entry index being an identification. For example, there exists the configuration information of M sets of resources. The network-side device can indicate the identification through the DCI, for example, ceil(log 2(M)) bits are carried through the DCI to indicate the configuration information of one set of resources in the configuration information of M sets of resources. For example, as shown in the table 2, M=4, then the configuration information can be indicated through 2 bits. The relationship between indication carried in the DCI and the identification can be shown in the preceding table 3.

For example, if the indication carried in the DCI is 00, then the identification corresponding to the indication can be determined to be Entry #0, and then it is determined that the configuration information corresponding to Entry #0 is the configuration information of the resources used by the network-side device to perform the interference measurement according to the table 3.

FIG. 12 is a schematic flowchart illustrating yet another information receiving method according to embodiments of the present disclosure. As shown in FIG. 12, the method of FIG. 10 further includes steps S1201 and S1202.

In step S1201, the second indication information sent by the network-side device is received.

In step S1202, it is determined, based on the second indication information, that the network-side device de-activates the interference measurement on the resources.

In an embodiment of the present disclosure, the second indication information is used to indicate to the terminal that the network-side device stops performing interference measurement on the resources. In a possible embodiment of the present disclosure, the first indication information is used to instruct the terminal to start receiving transmissions (including the data and/or reference signals) on the resources corresponding to the configuration information, or to start performing a preset operation on the resources corresponding to the configuration information.

In an embodiment, the interference measurement performed by the network-side device may be stopped as needed. When the interference measurement on the resources is stopped, the terminal may be instructed by the second indication information to make the terminal determine that the network-side device de-activates the interference measurement on the resources.

In an embodiment, the method further includes: receiving at least one of the following on the resources: data or reference signals. When the network-side device stops performing interference measurement on the resources, it may send the data or reference signals, etc. on the resources, and accordingly, the terminal may receive data or reference signals, etc. on the resources.

In an embodiment, the network-side device pre-configures configuration information for a plurality of resources for the terminal, and the first indication information is for indicating the configuration information for the resources for performing interference measurement activated by the network-side device among the plurality of resources.

The network-side device may pre-configure configuration information for a plurality of resources for the terminal, and activate, by the first indication information, one of the configuration information as the configuration information for the resources used by the network-side device for interference measurement. In an embodiment of the present disclosure, the first indication information and the second indication information may be the same information, and the network-side device may indicate information related to starting the interference measurement and ending the interference measurement by one indication information.

The network-side device indicates to the terminal the first indication information so that the terminal determines the resources used by the network-side device to perform interference measurement. For example, as shown in FIG. 9, the resources have a period of 2 slots, i.e., the network-side device performs the interference measurement on the resources according to the period, and the terminal stops receiving the data or the reference signals on the resources according to the period.

The network-side device stops performing the interference measurement on the resources after completing the interference measurement (or for other reasons), which can be indicated to the terminal by the first indication information, to make the terminal determine that the network-side device stops performing the interference measurement on the resources. That is, the network-side device stops performing the interference measurement on the resources, and thus, can send data or reference signals on the resources, and the terminal can also receive data or reference signals on the resources.

Corresponding to the aforementioned embodiments of the resource indication method and the information receiving method, the present disclosure also provides embodiments of a resource indication apparatus and an information receiving apparatus.

Embodiments of the present disclosure propose the resource indication apparatus, which may be performed by the network-side device. The network-side device includes but is not limited to a network-side device in a communication system such as 4G, 5G, 6G, etc., including a base station, a core network and so on. The network-side device can communicate with a terminal, and the terminal includes but is not limited to a communication device such as a cell phone, a tablet, a wearable device, a sensor, an Internet of Things device, etc.

In an embodiment, the resource indication apparatus includes one or more processors, the processors being configured to: determining resources for performing interference measurement; and sending, to a terminal, first indication information for indicating configuration information for the resources.

In an embodiment, the processor is further configured to: stopping sending data or reference signals on the resources.

In an embodiment, the resources include at least one of: downlink slots of a time division duplex (TDD) frequency band; or downlink spectrums of a frequency division duplex (FDD) frequency band.

In an embodiment, the first indication information includes at least one of: Downlink Control Information (DCI); or Media Access Control Control Element (MAC CE).

In an embodiment, the DCI includes common Downlink Control Information (common DCI).

In an embodiment, the configuration information includes at least one of: frequency domain occupancy information, time domain occupancy information, a time domain resource range, or pattern information for the frequency domain occupancy information and the time domain occupancy information.

In an embodiment, the frequency domain occupancy information includes a frequency domain start location and a frequency domain range.

In an embodiment, the pattern information is determined based on a protocol agreement, or, the processor is further configured for:
indicating the pattern information to the terminal.

In an embodiment, granularity of the pattern information is determined based on the protocol agreement, or, the processor is further configured for: indicating the granularity to the terminal.

In an embodiment, the processor is configured for: determining target identification corresponding to the configuration information based on an association between identification and configuration information; and carrying the target identification in the first indication information to be transmitted to the terminal.

In an embodiment, the processor is further configured for: in response to the interference measurement on the resources being stopped, sending, to the terminal, second indication information for indicating that the network-side device de-activates the interference measurement on the resources.

In an embodiment, the processor is further configured for: sending on the resources at least one of: data or reference signals.

In an embodiment, the network-side device pre-configures configuration information for a plurality of resources for the terminal, and the first indication information is for indicating configuration information for the resources for performing interference measurement activated by the network-side device among the plurality of resources.

Embodiments of the present disclosure propose the information receiving apparatus, which may be performed by the terminal. The terminal includes but is not limited to a communication device such as a cell phone, a tablet, a wearable device, a sensor, an Internet of Things device, etc. The terminal can communicate with the network-side device, and the network-side device includes but is not limited to a network-side device in a communication system such as 4G, 5G, 6G, etc., including a base station, a core network and so on.

In an embodiment, the information receiving device includes one or more processors, the processors being configured for: receiving first indication information from a network-side device; and determining, based on the first indication information, configuration information for resources for the network-side device performing interference measurement.

In an embodiment, the processor is further configured for: performing rate matching for the resources to stop receiving data or reference signals sent by the network-side device on the resources.

In an embodiment, the resource includes at least one of: downlink slots of a time division duplex (TDD) frequency band; or downlink spectrums of a frequency division duplex (FDD) frequency band.

In an embodiment, the first indication information includes at least one of: Downlink Control Information (DCI); or Media Access Control Control Element (MAC CE).

In an embodiment, the DCI includes common Downlink Control Information (common DCI).

In an embodiment, the configuration information includes at least one of: frequency domain occupancy information, time domain occupancy information, a time domain resource range, pattern information for the frequency domain occupancy information and the time domain occupancy information.

In an embodiment, the frequency domain occupancy information includes a frequency domain start location and a frequency domain range.

In an embodiment, the pattern information is determined based on a protocol agreement or, the processor is further configured for: determining the pattern information based on indication from the network-side device.

In an embodiment, granularity of the pattern information is determined based on the protocol agreement, or, the processor is further configured for: determining the granularity based on indication from the network-side device.

In an embodiment, the processor is further configured for: determining target identification in the first indication information; and determining the configuration information corresponding to the target identification based on an association between identification and configuration information.

In an embodiment, the processor is further configured for: receiving second indication information from the network-side device; and determining, based on the second indication information, that the network-side device de-activates the interference measurement on the resources.

In an embodiment, the processor is further configured for: receiving on the resources at least one of: data or reference signals.

In an embodiment, there is configuration information for a plurality of resources which is pre-configured by the network-side device for the terminal, and the first indication information is for indicating configuration information for the resources for performing interference measurement activated by the network-side device among the plurality of resources.

With regard to the device in the above examples, the specific manner in which the respective modules perform the operations has been described in detail in the examples of the related methods, and will not be explained in detail herein.

Since the device examples substantially correspond to the method examples, a reference may be made to part of the descriptions of the method examples for the related part. The apparatus examples described above are merely illustrative, where the modules described as separate members may be or not be physically separated, and the members displayed as modules may be or not be physical units, i.e., may be located in one place, or may be distributed in a plurality of network modules. Part or all of the modules may be selected according to actual requirements to implement the objectives of the solutions in the examples. Those of ordinary skill in the art may understand and carry out them without creative work.

Embodiments of the present disclosure also propose a communication device including: a processor; and a memory for storing a computer program; where, the computer program, when is executed by the processor, implements the resource indication method described in any of the above embodiments.

Embodiments of the present disclosure also propose a communication device including: a processor; and a memory for storing a computer program; where, the computer program, when is executed by the processor, implements the information receiving method described in any of the above embodiments.

Embodiments of the present disclosure also propose a computer-readable storage medium for storing a computer program, where the computer program, when is executed by a processor, implements the resource indication method described in any of the above embodiments.

Embodiments of the present disclosure also propose a computer-readable storage medium for storing a computer program, where the computer program, when is executed by a processor, implements the information receiving method described in any of the above embodiments.

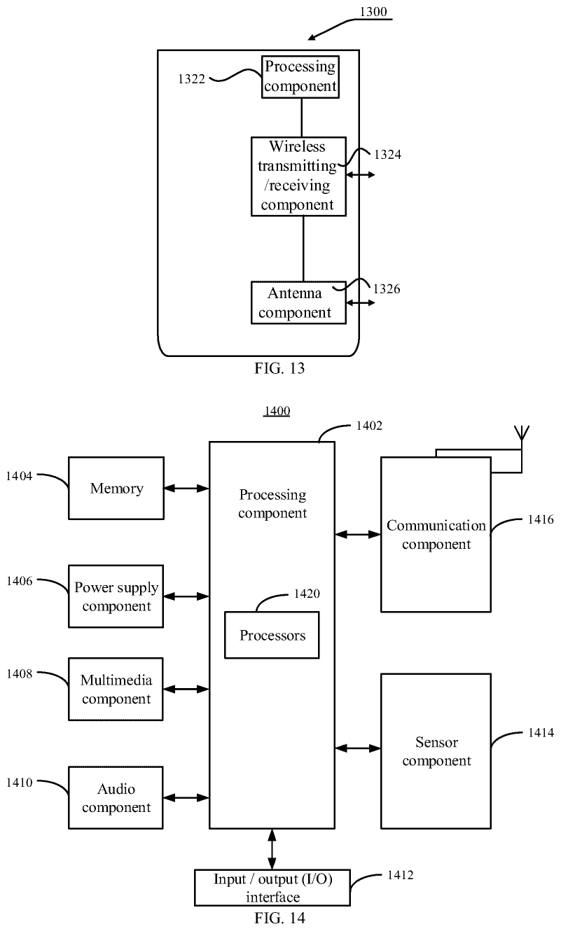

As shown in FIG. 13, FIG. 13 is a schematic block diagram illustrating a resource indication apparatus 1300 according to embodiments of the present disclosure. The resource indication apparatus 1300 may be provided as a base station. Referring to FIG. 13, the apparatus 1300 includes a processing component 1322, a wireless transmitting/receiving component 1324, an antenna component 1326, and a signal processing portion specific to a wireless interface. The processing component 1322 may further include one or more processors. One of the processors in the processing component 1322 may be configured to implement the resource indication method described in any of the above embodiments.

FIG. 14 is a schematic block diagram illustrating an information receiving apparatus 1400 according to embodiments of the present disclosure. For example, the information receiving apparatus 1400 may be a mobile phone, a computer, a digital broadcasting terminal, a messaging device, a game console, a tablet device, a medical device, a fitness device, a personal digital assistant and the like.

Referring to FIG. 14, the apparatus 1400 may include one or more of the following components: a processing component 1402, a memory 1404, a power supply component 1406, a multimedia component 1408, an audio component 1410, an input/output (I/O) interface 1412, a sensor component 1414, and a communication component 1416.

The processing component 1402 usually controls overall operations of the apparatus 1400, such as operations related to display, a telephone call, data communication, a camera operation and a record operation. The processing component 1402 may include one or more processors 1420 to execute instructions to accomplish all or some of the steps of the information receiving method described above. In addition, the processing component 1402 may include one or more modules to facilitate interaction between the processing component 1402 and other components. For example, the processing component 1402 may include a multimedia module to facilitate interaction between the multimedia component 1408 and the processing component 1402.

The memory 1404 is configured to store various types of data to support the operations of the apparatus 1400. Examples of such data include instructions, contact data, phonebook data, messages, pictures, videos, and so on for any application or method that operates on the apparatus 1400. The memory 1404 may be implemented by any type of volatile or non-volatile storage devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk, or a CD-ROM.

The power supply component 1406 provides power for various components of the apparatus 1400. The power supply component 1406 may include a power management system, one or more power sources, and other components associated with generating, managing, and distributing power for the apparatus 1400.

The multimedia component 1408 includes a screen for providing an output interface between the apparatus 1400 and a user. In some embodiments, the screen may include a liquid crystal display (LCD) and a touch panel (TP). If the screen includes a touch panel, the screen may be implemented as a touch screen to receive an input signal from a user. The touch panel includes one or more touch sensors for sensing a touch, a slide and a gesture on the touch panel. The touch sensor may not only sense a boundary of a touching or sliding movement, but also detect wake-up duration and pressure related to the touching or sliding operation. In some embodiments, the multimedia component 1408 may include a front camera and/or a rear camera. The front camera and/or the rear camera may receive external multimedia data when the apparatus 1400 is in an operational mode, such as a shooting mode or a video mode. Each of the front camera and the rear camera may be a fixed optical lens system or be of a focal length and a capability of an optical zoom.

The audio component 1410 is configured to output and/or input an audio signal. For example, the audio component 1410 includes a microphone (MIC). When the apparatus 1400 is in an operating mode, such as a call mode, a recording mode and a speech recognition mode, the microphone is configured to receive an external audio signal. The received audio signal may be further stored in the memory 1404 or sent via the communication component 1416. In some examples, the audio component 1410 also includes a speaker for outputting an audio signal.

The I/O interface 1412 may provide an interface between the processing component 1402 and peripheral interface modules. The above peripheral interface modules may include a keyboard, a click wheel, buttons and so on. These buttons may include but not limited to, a home button, a volume button, a start button and a lock button.

The sensor component 1414 includes one or more sensors for providing state assessments in different aspects for the apparatus 1400. For example, the sensor component 1414 may detect an on/off state of the apparatus 1400 and a relative location of components. For example, the components are a display and a keypad of the apparatus 1400. The sensor component 1414 may also detect a position change of the apparatus 1400 or a component of the apparatus 1400, presence or absence of a touch of a user on the apparatus 1400, an orientation or acceleration/deceleration of the apparatus 1400, and a temperature change of apparatus 1400. The sensor component 1414 may include a proximity sensor for detecting the existence of a nearby object without any physical touch. The sensor component 1414 may also include an optical sensor, such as a CMOS or CCD image sensor used in an imaging application. In some examples, the sensor component 1414 may also include an acceleration sensor, a gyro sensor, a magnetic sensor, a pressure sensor, or a temperature sensor.

The communication component 1416 is configured to facilitate wired or wireless communication between the apparatus 1400 and other devices. The apparatus 1400 may access a wireless network based on a communication standard, such as WiFi, 2G or 3G, or a combination thereof. In an example, the communication component 1416 the communication component 1416 may receive a broadcast signal or broadcast-related information from an external broadcast management system via a broadcast channel. In an example, the communication component 1416 may also include a near field communication (NFC) module to facilitate short-range communications. For example, the NFC module may be implemented based on radio frequency identity (RFID) technology, infrared data association (IrDA) technology, ultra-wideband (UWB) technology, bluetooth (BT) technology and other technologies.

In an example, the apparatus 1400 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic elements, for executing the information receiving method in any one of the above examples.

In an example, there is also provided anon-transitory computer-readable storage medium including instructions, such as a memory 1404 including instructions, the instructions being executable by a processor 1420 of the apparatus 1400 to accomplish the information receiving method. For example, the non-transitory computer readable storage medium may be a ROM, random access memory (RAM), a CD-ROM, a magnetic tape, a floppy disk, and an optical data storage device, and the like.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the art that are not disclosed in the present disclosure. The specification and examples herein are intended to be illustrative only and the real scope and spirit of the present disclosure are indicated by the following claims of the present disclosure.

It is to be understood that the present disclosure is not limited to the precise structures described above and shown in the accompanying drawings and may be modified or changed without departing from the scope of the present disclosure. The scope of the disclosure is to be limited only by the appended claims.

It shall be noted that the relational terms such as “first” and “second” used herein are merely intended to distinguish one entity or operation from another entity or operation rather than to require or imply any such actual relation or order existing between these entities or operations. Also, the term “including”, “containing” or any variation thereof is intended to encompass non-exclusive inclusion, so that a process, method, article or device including a series of elements includes not only those elements but also other elements not listed explicitly or those elements inherent to such a process, method, article or device. Without more limitations, an element defined by the statement “including a . . . ” shall not be precluded to include additional same elements present in a process, method, article or device including the elements.

The above are detailed description of a method and a device provided according to the examples of the present disclosure. Specific examples are used herein to set forth the principles and the implementing methods of the present disclosure, and the descriptions of the above examples are only meant to help understanding of the method and the core idea of the present disclosure. Meanwhile, those of ordinary skill in the art may make alterations to the specific examples and the scope of application in accordance with the idea of the present disclosure. In conclusion, the contents of the present specification shall not be interpreted as limiting the present disclosure.

1. A resource indication method, performed by a network-side device, the method comprising:
determining resources for performing interference measurement; and
sending, to a terminal, first indication information for indicating configuration information for the resources.

2. (canceled)

3. The method according to claim 1, wherein the resources comprise at least one of:
downlink slots of a time division duplex (TDD) frequency band; or
downlink spectrums of a frequency division duplex (FDD) frequency band.

4. The method according to claim 1, wherein the first indication information comprises at least one of:
Downlink Control Information (DCI); or
Media Access Control Control Element (MAC CE), and
wherein the DCI comprises common Downlink Control Information (common DCI).

5. (canceled)

6. The method according to claim 1, wherein the configuration information comprises at least one of:
frequency domain occupancy information, time domain occupancy information, a time domain resource range, or pattern information for the frequency domain occupancy information and the time domain occupancy information,
wherein the frequency domain occupancy information comprises a frequency domain start location and a frequency domain range,
wherein the pattern information is determined based on a protocol agreement or the method further comprises:
indicating the pattern information to the terminal, and
wherein granularity of the pattern information is determined based on a protocol agreement or the method further comprises:
indicating the granularity to the terminal.

7-9. (canceled)

10. The method according to claim 1, wherein sending, to the terminal, the first indication information comprises:
determining target identification corresponding to the configuration information based on an association between identification and configuration information; and
carrying the target identification in the first indication information to be transmitted to the terminal.

11. The method according to claim 1, in response to the network device performing interference measurement on the resources, the method further comprising at least one of:
stopping sending data or reference signals on the resources; or
in response to the interference measurement on the resources being stopped, sending, to the terminal, second indication information for indicating that the network-side device de-activates the interference measurement on the resources, and
sending on the resources at least one of: data or reference signals.

12. (canceled)

13. The method according to claim 1, wherein the network-side device pre-configures configuration information for a plurality of resources for the terminal, and the first indication information is for indicating configuration information for the resources for performing interference measurement activated by the network-side device among the plurality of resources.

14. An information receiving method, performed by a terminal, comprising:
receiving first indication information from a network-side device; and
determining, based on the first indication information, configuration information for resources for the network-side device performing interference measurement.

15. The method according to claim 14, further comprising:
performing rate matching for the resources to stop receiving data or reference signals sent by the network-side device on the resources.

16. The method according to claim 14, wherein the resources comprise at least one of:
downlink slots of a time division duplex (TDD) frequency band; or
downlink spectrums of a frequency division duplex (FDD) frequency band.

17. The method according to claim 14, wherein the first indication information comprises at least one of:
Downlink Control Information (DCI); or
Media Access Control Control Element (MAC CE), and
wherein the DCI comprises common Downlink Control Information (common DCI).

18. (canceled)

19. The method according to claim 14, wherein the configuration information comprises at least one of:
frequency domain occupancy information, time domain occupancy information, a time domain resource range, pattern information for the frequency domain occupancy information and the time domain occupancy information,
wherein the frequency domain occupancy information comprises a frequency domain start location and a frequency domain range,
wherein the pattern information is determined based on a protocol agreement or the method further comprises:
determining the pattern information based on indication from the network-side device, and
wherein granularity of the pattern information is determined based on a protocol agreement or the method further comprises:
determining the granularity based on indication from the network-side device.

20-22. (canceled)

23. The method according to claim 14, wherein determining, based on the first indication information, the configuration information for the resources for the network-side device performing interference measurement comprises:
determining target identification in the first indication information; and
determining the configuration information corresponding to the target identification based on an association between identification and configuration information.

24. The method according to claim 14, further comprising:
receiving second indication information from the network-side device; and
determining, based on the second indication information, that the network-side device de-activates the interference measurement on the resources; and
receiving on the resources at least one of: data or reference signals.

25. (canceled)

26. The method according to claim 14, wherein there is configuration information for a plurality of resources which is pre-configured by the network-side device for the terminal, and the first indication information is for indicating configuration information for the resources for performing interference measurement activated by the network-side device among the plurality of resources.

27. A resource indication apparatus comprising one or more processors, the one or more processors being configured for:
determining resources for performing interference measurement; and
sending, to a terminal, first indication information for indicating configuration information for the resources.

28. An information receiving apparatus comprising one or more processors, the one or more processors being configured for implementing the information receiving method of claim 14.

29. A communication device comprising:
a processor; and
a memory for storing a computer program, and
wherein the computer program, when is executed by the processor, causes the processor to implement the resource indication method of claim 1.

30. A communication device comprising:
a processor; and
a memory for storing a computer program, and
wherein the computer program, when is executed by the processor causes the processor to implement the information receiving method of claim 14.

31. A non-transitory computer readable storage medium for storing a computer program, wherein the computer program, when is executed by a processor causes the processor to implement the resource indication method of claim 1.

32. (canceled)
